(19) United States
(12) Patent Application Publication
(10) Pub. No.: US 2025/0286212 A1
(43) Pub. Date: Sep. 11, 2025

(54) BATTERY PACK FIRE EXTINGUISHER

(71) Applicant: SAMSUNG SDI CO., LTD., Yongin-si (KR)

(72) Inventor: Tae Jin LEE, Yongin-si (KR)

(21) Appl. No.: 18/830,079

(22) Filed: Sep. 10, 2024

(30) Foreign Application Priority Data
Mar. 6, 2024 (KR) 10-2024-0032185

(51) Int. Cl. H01M 50/383; A62C 3/16; A62C 35/10; H01M 50/213; H01M 50/673

(52) U.S. Cl. CPC H01M 50/383; A62C 3/16; A62C 35/10; H01M 50/213; H01M 50/673

(57) ABSTRACT

A battery pack fire extinguisher includes: a plurality of battery cells; a bottom case accommodating the battery cells; a top case coupled to the bottom case; and a fire extinguishing capsule attached to the top case and comprising a fire extinguishing agent sheet embedded therein. The fire extinguishing capsule includes: an injection portion having injection holes for spraying a fire extinguishing agent toward the battery cells from the fire extinguishing agent sheet; and a guide portion protruding beyond the injection portion toward the battery cells around the injection portion.

### CROSS-REFERENCE TO RELATED APPLICATION

The present application claims priority to and the benefit of Korean Patent Application No. 10-2024-0032185 filed in the Korean Intellectual Property Office on Mar. 6, 2024, the entire disclosure of which is incorporated herein by reference.

### BACKGROUND

### 1. Field

Aspects of embodiments of the present disclosure relate to a battery pack fire extinguisher.

### 2. Description of the Related Art

Currently, when ignition occurs due to, for example, an accident or battery failure in an electric vehicle, a barrier is installed around the ignited vehicle and filled with water to cool the battery and extinguish the fire.

Thus, early fire extinguishing response is difficult before fire trucks arrive, and extinguishing battery fires require a lot of time and a large amount of water. In addition, because fire extinguishing water is sprayed from the outside of the electric vehicle, fire extinguishing efficiency is very low.

Electric vehicles or energy storage systems include battery packs. When a fire occurs in one battery cell of the battery pack during operation, the flame is, ideally, removed to prevent the ignition from spreading to other, surrounding battery cells.

### SUMMARY

Embodiments of the present disclosure provide a battery pack fire extinguisher that prevents fire by blocking flames from spreading to surrounding battery cells when a fire occurs in one battery cell.

Embodiments of the present disclosure provide a battery pack fire extinguisher that effectively induces ignition of a fire extinguishing agent by directing flame to the fire extinguishing agent with a built-in fire extinguishing function.

A battery pack fire extinguisher, according to an embodiment of the present disclosure, includes: a plurality of battery cells; a bottom case accommodating the battery cells; a top case coupled to the bottom case; and a fire extinguishing capsule attached to the top case and including a fire extinguishing agent sheet embedded therein. The fire extinguishing capsule includes an injection portion having injection holes for spraying a fire extinguishing agent toward the battery cells from the fire extinguishing agent sheet and a guide portion protruding beyond the injection portion toward the battery cells at an outer surface of the injection portion.

The battery cells may be cylindrical rechargeable batteries.

The fire extinguishing capsule may include a back plate spaced apart from the injection portion and connected to the guide portion.

The fire extinguishing agent sheet may be attached to an inner side of the injection portion with a first impact prevention pad therebetween.

The fire extinguishing agent sheet may be attached to the back plate with a second impact prevention pad therebetween on an inner surface of the back plate.

The injection portion may be a circle, and the guide portion may have a circular stripe shape having a width in a diameter direction at an outer side of the injection portion and parallel with the back plate.

The injection portion may have a quadrangular shape, and the guide portion may have a quadrangular stripe shape having a width at an outer side of the injection portion and parallel with the back plate.

The injection portion may have circular-shaped injection holes or slot-shaped injection holes.

The fire extinguishing capsule may include aluminum.

The injection portion may have a circular shape, and the guide portion may have an inclined surface having a width in a diameter direction at an outer side of the injection portion and forming an angle with respect to the back plate.

The injection portion may have a quadrangular shape, and the guide portion may have an inclined surface having a width in a diameter direction at an outer side of the injection portion and forming an angle with respect to the back plate.

The injection portion may have a circular shape, and the guide portion may have a concavely curved surface curved toward a center of the injection portion, have a width in a diameter direction at an outer side of the injection portion, and form an angle with respect to the back plate.

The injection portion may have a quadrangular shape, and the guide portion may have a concavely curved surface curved toward a center of the injection portion, have a width in a diameter direction at an outer side of the injection portion, and form an angle with respect to the back plate.

The fire extinguishing capsule may be arranged one per plurality of the battery cells.

According to embodiments of the present disclosure, a fire extinguishing capsule embedded with the fire extinguishing agent sheet is installed in (or on) the top case, and a flame from a battery cell is guided by the guide portion through the injection portion to the fire extinguishing capsule to ignite the fire extinguishing agent sheet to extinguish the flame of the battery cell by using the smoke generated by the fire extinguishing agent.

Therefore, embodiments of the present disclosure can prevent fire from engulfing the entire battery pack by blocking the spread of flames to surrounding battery cells when a fire occurs in one battery cell. In addition, embodiments of the present disclosure can effectively prevent fire from engulfing the entire battery pack by quickly igniting the fire extinguishing agent by directly guiding a flame to the fire extinguishing agent having the fire extinguishing along the guide portion.

### BRIEF DESCRIPTION OF THE DRAWINGS

FIG. 1 is a top plan view of a battery pack fire extinguisher according to an embodiment of the present disclosure.

FIG. 2 is a cross-sectional view taken along the line II-II in FIG. 1.

FIG. 3 is a cross-sectional view of a fire extinguishing capsule in which a fire extinguishing agent sheet shown in FIG. 2 is embedded.

FIG. 4 is a bottom view of the fire extinguishing capsule shown in FIG. 3.

FIG. 5 is a bottom view of the fire extinguishing capsule shown in FIG. 3 according to another embodiment.

FIG. 6 is a cross-sectional view of a battery pack fire extinguisher according to another embodiment of the present disclosure.

FIG. 7 is a cross-sectional view of a battery pack fire extinguisher according to another embodiment of the present disclosure.

### DETAILED DESCRIPTION

The present disclosure will be described more fully hereinafter with reference to the accompanying drawings, in which embodiments of the present disclosure are shown. As those skilled in the art would realize, the described embodiments may be modified in various different ways, all without departing from the spirit or scope of the present disclosure. The drawings and description are to be regarded as illustrative in nature and not restrictive.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

When a fire occurs in one battery cell of a battery pack including a plurality of battery cells, a fire extinguishing capsule including (or containing) a fire extinguishing agent is used to extinguish the flame and prevent the fire from spreading to other battery cells in the battery pack. The fire extinguishing capsule extinguishes flames caused due to a fire in the battery pack. The fire extinguishing capsule embedded in the battery pack prevents or at least mitigates the spread of the fire by extinguishing the flame in the shortest possible time.

Pouch-type, square, or circular battery cells may be used in the battery pack. The following embodiment illustrates a battery pack using circular battery cells as an example. To prevent chain ignition of battery cells, the battery pack includes a fire extinguishing capsule containing a fire extinguishing agent.

The fire extinguishing capsule is installed in a structure that takes into account the operation characteristics at an upper portion of the battery cell, which is a frequent ignition source. The fire extinguishing capsule is combusted by the flame of an ignited battery cell to generate smoke, and the smoke extinguishes the flame of the battery cell.

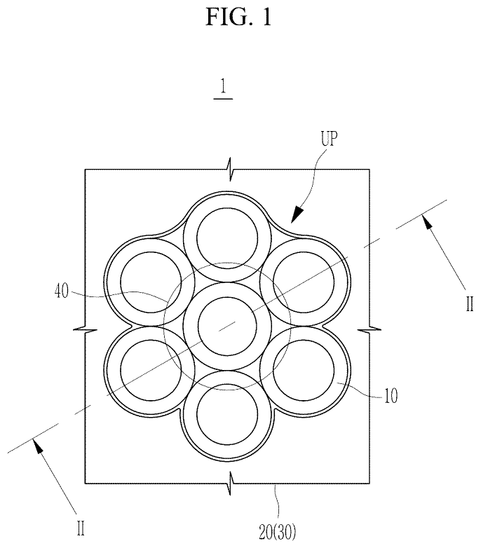

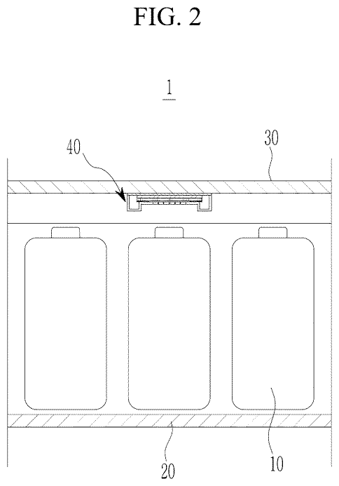

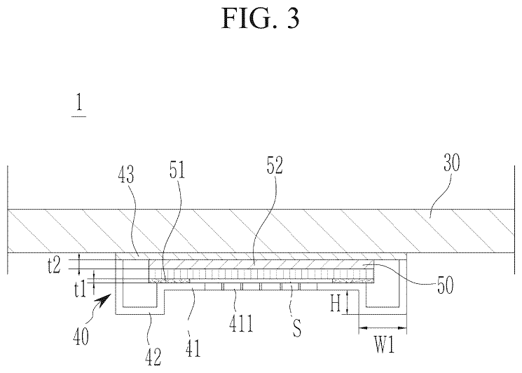

FIG. 1 is a top plan view of a battery pack fire extinguisher according to an embodiment of the present disclosure, and FIG. 2 is a cross-sectional view taken along the line II-II in FIG. 1. Referring to FIG. 1 and FIG. 2, a battery pack fire extinguisher 1 includes a plurality of battery cells 10, a bottom case 20 accommodating the battery cells 10, a top case 30 coupled to the bottom case 20, and a fire extinguishing capsule 40 attached to the top case 30 and in which a fire extinguishing agent sheet 50 is embedded (see, e.g., FIG. 3).

As an example, the battery cell 10 is a cylindrical rechargeable battery. The illustrated embodiment is a configuration including seven battery cells 10 and one fire extinguishing capsule 40. When seven battery cells 10 and one fire extinguishing capsule 40 are used as a unit pack UP, the illustrated embodiment is a configuration including one unit pack UP. However, the battery pack fire extinguisher 1 may be formed by iteratively arranging the unit pack UP in the up and down and left and right directions (e.g., horizontal directions) of FIG. 1 according to the desired capacity.

A temperature at which the fire extinguishing agent embedded in the fire extinguishing agent sheet 50 ignites (or combusts) may be in a range between about 380° C. and about 400° C., and in one embodiment, may be about 390° C. Depending on the structure of the fire extinguishing capsule 40, the fire extinguishing agent of the fire extinguishing agent sheet 50 may be ignited (or combusted) at the beginning of (e.g., soon after) ignition of the battery cell 10.

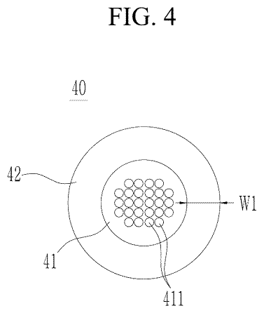

FIG. 3 is a cross-sectional view of the fire extinguishing capsule embedded with the fire extinguishing agent sheet shown in FIG. 2, and FIG. 4 is a bottom view of the fire extinguishing capsule shown in FIG. 3. Referring to FIG. 3 and FIG. 4, the fire extinguishing capsule 40 includes an injection portion 41 and a guide portion 42 and may further include a back plate 43. As an example, the fire extinguishing capsule 40 may be formed of aluminum, which has high thermal conductivity.

The injection portion 41 has injection holes 411 that spray the fire extinguishing agent from the fire extinguishing agent sheet 50 toward the battery cell 10. When a battery cell 10 ignites, the injection holes 411 allow for the inflow of the flame generated from battery cell 10 such that the flame reaches the fire extinguishing agent sheet 50. In response, the fire extinguishing agent sheet 50 is configured to start ignition and combustion operation due to the ignition heat of the battery cell 10.

The guide portion 42 protrudes from an outer surface of the injection portion 41 toward the battery cell 10 to a height H. The height H of the guide portion 42 guides the flame generated from the battery cell 10 toward the injection portion 41 such that the flame reaches the fire extinguishing agent sheet 50 through the injection holes 411.

As an example, the fire extinguishing agent sheet 50 is attached to an inner surface of the injection portion 41 via a first impact prevention pad 51 on an inner surface of the injection portion 41. In such an embodiment, the first impact prevention pad 51 may be a PET film with high thermal conductivity so that it quickly reaches the temperature that ignites the fire extinguishing agent. In addition, the first impact prevention pad 51 may be a sponge to increase vibration and impact absorption.

The first impact prevention pad 51 has a first thickness t1. Therefore, a space S is formed between the inner surface of the injection portion 41 and the fire extinguishing agent sheet 50. The space S is a part of (e.g., is open to) the injection holes 411 and diffuses the inflowed flame, and thus, the entire surface of the fire extinguishing agent sheet 50 can be evenly exposed to the flame. Therefore, uniform ignition start and combustion operation of the fire extinguishing agent sheet 50 is possible.

In addition, a space on the outer surface of the injection portion 41, which is formed by the height H of the guide portion 42, temporarily stores the flame that inflows into the injection holes 411, thereby enabling a uniform flame inflow into the injection holes 411. Therefore, the entire surface of the fire extinguishing agent sheet 50 can be evenly exposed to the flame and uniform ignition and combustion operation for the entire fire extinguishing agent sheet 50 is ensured.

The back plate 43 is spaced apart from the injection portion 41 and is connected to the guide portion 42. Therefore, the fire extinguishing capsule 40 may have a space in which the fire extinguishing agent sheet 50 may be embedded. In addition, the back plate 43 is installed on an inner surface of the top case 30.

In addition, a second impact prevention pad 52 may be disposed between the fire extinguishing agent sheet 50 and the back plate 43. In such an embodiment, the second impact prevention pad 52 may be a PET film with high thermal conductivity to quickly reach the temperature that ignites the fire extinguishing agent.

Because the second impact prevention pad 52 has (or covers) a wider area than the first impact prevention pad 51, it can more effectively absorb vibration and impact at areas that are more vulnerable to vibration and impact than the first impact prevention pad 51.

In addition, the second impact prevention pad 52 has a second thickness t2. The second thickness t2 may be larger than the first thickness t1 of the first impact prevention pad 51, thereby increasing vibration and impact absorption transmitted from the top case 30. Accordingly, damage to fire extinguishing agent sheet 50 can be more effectively prevented.

The injection portion 41 has a circular shape, and the guide portion 42 has a width W1 in the diameter direction at the outside of (e.g., around) the injection portion 41, is parallel to the back plate 43, and may have a circular stripe. As an example, the injection holes 411 in the injection portion 41 may have a circular shape.

The injection holes 411 allow the flame generated from battery cell 10 to inflow into the fire extinguishing agent sheet 50 such that the fire extinguishing agent is stably combusted and the smoke is stably discharged to extinguish the flame. For example, the injection holes 411 have a size that prevents the fire extinguishing agent from combusting and falling from the fire extinguishing agent sheet 50.

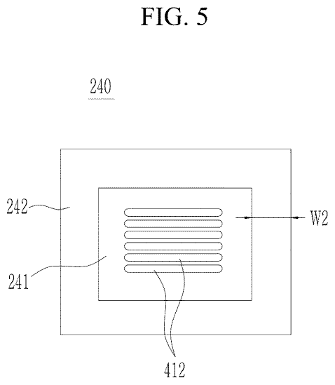

FIG. 5 is a bottom view of the fire extinguishing capsule shown in FIG. 3 according to another embodiment. Referring to FIG. 5, in the fire extinguishing capsule 240, the injection portion 241 has a quadrangular shape, and the guide portion 242 has a width W2 at the outside of the injection portion 241, is parallel to the back plate 43, and may have a quadrangle band shape. As an example, the injection holes 412 in the injection portion 241 may have a slot shape.

When a diameter of the circular injection hole 411 and a width of the slot-type injection hole 412 are the same, the slot-type injection hole 412 provides a larger reach area for the flame to reach the fire extinguishing agent sheet 50 compared to the circular-shaped injection hole 411, thereby causing ignition of the extinguishing agent to start more quickly.

When the diameter of the circular injection hole 411 and the width of the slot-type injection hole 412 are the same, the circular injection hole 411 can more continuously supply the fire extinguishing smoke from fire extinguishing agent sheet 50 to the battery cell 10 compared to the slot-type injection hole 412.

A circular injection hole and a slot-type injection hole may be mixed and applied to (e.g., may be present together in) the injection portion. In such an embodiment, the two shapes of injection holes optimize shortening of the ignition start of the fire extinguishing agent and extending of the duration of the extinguishing smoke.

Referring back to FIG. 3, the injection portion 41 and the guide portion 42 are perpendicularly connected to each other. In the event of a fire in the battery cell 10, the generated flame is guided by the guide portion 42 toward the injection holes 411 in the injection portion 41 to reach the fire extinguishing agent sheet 50.

The fire extinguishing agent sheet 50 is heated by the ignited flame, and when an ignition start temperature thereof is reached, the fire extinguishing agent in the fire extinguishing agent sheet 50 ignites (e.g., combusts) and generates smoke. The smoke is injected into the flame of the ignited battery cell 10 through the injection holes 411 in the injection portion 41 such that the flame is quickly extinguished.

Therefore, due to the increase in the capacity of the battery cell 10, even in the event of a fire in the battery cell 10, the spread of flame from the battery cell 10 where the fire occurred to the surrounding battery cells 10 is blocked. That is, according to embodiments of the present disclosure, fires caused by ignition propagation with the battery cell 10 can be prevented.

Hereinafter, various embodiments of the present disclosure will be described. Compared to the above-described embodiment, the description of the same or substantially similar parts, components, configurations, and features may be omitted or only briefly described while the description of different aspects therebetween will be primarily described.

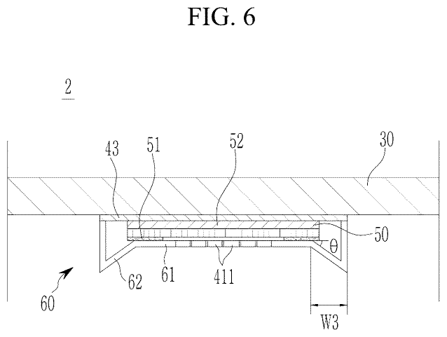

FIG. 6 is a cross-sectional view of a battery pack fire extinguisher according to another embodiment of the present disclosure. Referring to FIG. 4 to FIG. 6, in a fire extinguishing capsule 60 of a battery pack fire extinguisher 2, an injection portion 61 has a circular shape and a guide portion 62 has a width W3 in a diameter direction on the outside of (e.g., around) the injection portion 61 and has an inclined surface having an angle θ with respect to a back plate 43. The injection portion 61 has a plurality of injection holes 411.

Referring to FIG. 5 and FIG. 6, in the fire extinguishing capsule 240, an injection portion 241 has a quadrangular shape, and in a fire extinguishing capsule 60, a guide portion 62 has a width W3 in the diameter direction on the outside of an injection portion 61 and has an inclined surface having an angle θ with respect to a back plate 43. The injection portion 61 has a plurality of injection holes 412.

The injection portion 61 and the guide portion 62 having the inclined surface are connected to each other at an angle θ. Therefore, in the event of a fire in the battery cell 10, the generated flame is more smoothly guided by the guide portion 62 to the injection holes 411 or 412 of the injection portion 61 and reaches a fire extinguishing agent sheet 50.

Because the angle θ is an acute angle, the injection portion 61 and the guide portion 62 are connected at an obtuse angle to more effectively induce the flame into the injection portion 61. Compared to above-described embodiment, in which the injection portion 41 and the guide portion 42 are connected at a right angle, connecting the injection portion 61 and the guide portion 62 with an obtuse-angled inclined surface effectively induces the flame to the fire extinguishing agent sheet 50.

That is, the above-described embodiment may generate a flame vortex in the injection portion 41 and the guide portion 42, which are connected at a right angle, and while the present embodiment avoids a flame vortex in the injection portion 61 and the guide portion 62 because they are obliquely connected at the angle θ.

The fire extinguishing agent sheet 50 is heated by the flame, and when an ignition start temperature thereof is reached, the fire extinguishing agent within the fire extinguishing agent sheet 50 begins to ignite and generate smoke. The smoke is supplied to the flame of the ignited battery cell 10 through the injection holes 411 or 412 in the injection portion 61 such that the flame is quickly extinguished.

Therefore, due to the increase in the capacity of the battery cell 10, even in the event of a fire in the battery cell 10, the spread of flame from the battery cell 10 in which the fire occurred to the surrounding battery cells 10 is blocked. For example, fires caused by ignition propagation with the battery cell 10 can be prevented.

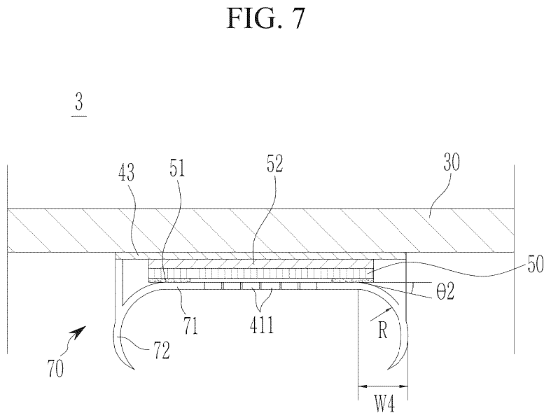

FIG. 7 is a cross-sectional view of a battery pack fire extinguisher according to another embodiment of the present disclosure. Referring to FIG. 4 to FIG. 7, in a fire extinguishing capsule 70 of a battery pack fire extinguisher 3, an injection portion 71 has a circular shape and a guide portion 72 has a width W4 in the diameter direction on the outside of (e.g., around) the injection portion 71 and has a curved surface having a concave curvature toward a center of the injection portion 71 with a radius R while forming an angle θ2 with respect to a back plate 43. The injection portion 71 has a plurality of injection holes 411.

Referring to FIG. 5 to FIG. 7, in the fire extinguishing capsule 240, an injection portion 241 has a quadrangular shape, and in a fire extinguishing capsule 70, a guide portion 72 has a width W4 in the diameter direction on the outside of an injection portion 71 and has a curved surface with a concave curvature toward a center of the injection portion 71 while forming an angle θ2 with respect to the back plate 43.

The injection portion 71 has a plurality of injection holes 411.

The guide portion 72 is formed as a curved surface with a concave curvature toward the center of the injection portion 71 and is connected to the injection portion 71. Therefore, in the event of a fire in the battery cell 10, the generated flame is guided by the guide portion 72 to the injection holes 411 or 412 in the injection portion 71 to reach the fire extinguishing agent sheet 50.

Because the angle θ2 is formed as an acute angle, the injection portion 71 and the guide portion 72 are connected at an obtuse angle and form a curved surface with a concave curvature to enable more effective flame direction and induction. Compared to the structure of the above-described embodiment, in which the injection portion 61 and the guide portion 62 are connected obliquely at an angle θ, in the illustrated embodiment, the concave curved surface and connection thereof to the injection portion can effectively induce a flame to the fire extinguishing agent sheet 50.

For example, although the flame induction can be caused by (or directed by) the injection portion 61 and the guide portion 62, which are obliquely connected at the angle θ in the above-described embodiment, the flame induction can be generated more effectively in the injection portion 71 and the guide portion 72, which are formed with the curved surface of the concave curvature and are connected at the angle θ2 in the present embodiment.

The fire extinguishing agent sheet 50 is heated by the flame, and when the ignition start temperature thereof is reached, the fire extinguishing agent within the fire extinguishing agent sheet 50 starts to generate smoke. The smoke is supplied to the flame of the ignited battery cell 10 through the injection holes 411 or 412 in the injection portion 71 such that the flame is quickly extinguished.

Therefore, due to the increase in the capacity of the battery cell 10, even in the event of a fire in the battery cell 10, the spread of fire from the battery cell 10 where the fire occurred to surrounding battery cells 10 is blocked. For example, fires caused by ignition propagation with the battery cell 10 can be prevented.

Although embodiments of the present disclosure have been described in detail above, the scope of the present disclosure is not limited thereto, and various modifications and improvements of those skilled in the art using the basic concept of the present disclosure defined in the following claims and their equivalents also belong to the scope of the present disclosure.

### DESCRIPTION OF SOME REFERENCE SYMBOLS

| | |
|---|---|
| 1, 2, 3: battery pack fire extinguisher | 10: battery cell |
| 20: bottom case | 30: top case |
| 40: fire extinguishing capsule | 41: injection portion |
| 42: guide portion | 43: back plate |
| 50: fire extinguishing agent sheet | 51: first impact prevention pad |
| 52: second impact prevention pad | 60: fire extinguishing capsule |
| 61: injection portion | 62: guide portion |
| 70: fire extinguishing capsule | 71: injection portion |
| 72: guide portion | 240: fire extinguishing capsule |
| 241: injection portion | 242: guide portion |
| 411: injection holes | 412: injection hole |
| H: height | S: space |
| t1 : first thickness | t2: second thickness |
| UP: unit pack | W1: width |
| W2: width | W3: width |
| W4: width | θ: angle |
| θ2: angle | |

What is claimed is:

1. A battery pack fire extinguisher comprising:
a plurality of battery cells;
a bottom case accommodating the battery cells;
a top case coupled to the bottom case; and
a fire extinguishing capsule attached to the top case and comprising a fire extinguishing agent sheet embedded therein, the fire extinguishing capsule comprising:
an injection portion having injection holes for spraying a fire extinguishing agent toward the battery cells from the fire extinguishing agent sheet; and
a guide portion protruding beyond the injection portion toward the battery cells around the injection portion.

2. The battery pack fire extinguisher as claimed in claim 1, wherein the battery cells are cylindrical rechargeable batteries.

3. The battery pack fire extinguisher as claimed in claim 1, wherein the fire extinguishing agent sheet is attached to an inner side of the injection portion with a first impact prevention pad therebetween.

4. The battery pack fire extinguisher as claimed in claim 3, wherein the fire extinguishing capsule comprises a back plate spaced apart from the injection portion and connected to the guide portion, and
wherein the fire extinguishing agent sheet is attached to the back plate with a second impact prevention pad therebetween on an inner surface of the back plate.

5. The battery pack fire extinguisher as claimed in claim 1, wherein the fire extinguishing capsule comprises a back plate spaced apart from the injection portion and connected to the guide portion.

6. The battery pack fire extinguisher as claimed in claim 5, wherein the injection portion is circular, and
wherein the guide portion has a circular stripe shape having a width in a diameter direction at an outer side of the injection portion and parallel with the back plate.

7. The battery pack fire extinguisher as claimed in claim 5, wherein the injection portion has a quadrangular shape, and
wherein the guide portion has a quadrangular stripe shape having a width at an outer side of the injection portion and parallel with the back plate.

8. The battery pack fire extinguisher as claimed in claim 5, wherein the injection portion has a circular shape, and
wherein the guide portion has an inclined surface having a width in a diameter direction at an outer side of the injection portion and forms an angle with respect to the back plate.

9. The battery pack fire extinguisher as claimed in claim 5, wherein the injection portion has a quadrangular shape, and
wherein the guide portion has an inclined surface having a width in a diameter direction at an outer side of the injection portion and forms an angle with respect to the back plate.

10. The battery pack fire extinguisher as claimed in claim 5, wherein the injection portion as a circular shape, and
wherein the guide portion has a concavely curved surface curved toward a center of the injection portion, has a width in a diameter direction at an outer side of the injection portion, and forms an angle with respect to the back plate.

11. The battery pack fire extinguisher as claimed in claim 5, wherein the injection portion has a quadrangular shape, and
wherein the guide portion has a concavely curved surface curved toward a center of the injection portion, has a width in a diameter direction at an outer side of the injection portion, and forms an angle with respect to the back plate.

12. The battery pack fire extinguisher as claimed in claim 1, wherein the injection portion has circular-shaped injection holes or slot-shaped injection holes.

13. The battery pack fire extinguisher as claimed in claim 1, wherein the fire extinguishing capsule comprises aluminum.

14. The battery pack fire extinguisher as claimed in claim 1, wherein the fire extinguishing capsule is arranged one per plurality of the battery cells.
